(19) United States
(12) Patent Application Publication
(10) Pub. No.: US 2026/0366309 A1
(43) Pub. Date: Nov. 19, 2026

(54) FIRE-RESISTANT FLOORING SYSTEM

(71) Applicant: MC Products, Inc., Rancho Santa Margarita, CA (US)

(72) Inventors: Scott Harrison, Rancho Santa Margarita, CA (US); Brad Carpenter, Rancho Santa Margarita, CA (US)

(21) Appl. No.: 19/678,626

(22) Filed: May 15, 2026

Related U.S. Application Data
(60) Provisional application No. 63/807,237, filed on May 16, 2025.

(51) Int. Cl. E04F 15/10; C04B 9/00; C04B 28/30; C04B 41/48; C04B 41/50; C04B 41/52; E04B 1/94; C04B 111/62; C04B 111/82

(52) U.S. Cl. CPC E04F 15/107; C04B 9/00; C04B 28/30; C04B 41/4826; C04B 41/483; C04B 41/4853; C04B 41/488; C04B 41/5076; C04B 41/52; E04B 1/94; E04F 15/102; C04B 2111/62; C04B 2111/82

(57) ABSTRACT

A flooring system that includes a multi-layered coating that forms a durable finish a top surface of a various floor surfaces or sub-floors, and a) forms a stained or solid colored finished floor that is easy to clean, antimicrobial, and/or is highly durable, b) provides an alternative to floor covers such as tile, wood, linoleum, manufactured store/tile, stone, carpet, vinyl composition tile (VCT), ceramic tiles, hardwoods, wood floors, laminate, porcelain, natural stone, or other flooring materials, c) maintains or improves the fire rating of the floor, d) improves anti-microbial properties of floor surface, e) improves durability of floor surface, and/or f) simplifies the care and/or maintenance of the floor surface.

### REFERENCED APPLICATION

The present disclosure claims priority on United States Provisional Application Serial No. 63/807,237 filed May 16, 2025, which is fully incorporated herein by reference.

### FIELD OF DISCLOSURE

The present disclosure is directed to a flooring system that includes a multi-layered coating that forms a durable finish on a top surface of various floor surfaces or sub-floors; particularly to a flooring system that includes a multi-layered coating that forms a durable finish a top surface on magnesium cement floorboards, concrete floors, gypsum concrete floors, wood floors, wood sub-floors or other types of subfloors; more particularly to a flooring system that includes a multi-layered coating that forms a durable finish a top surface on magnesium cement floorboards, concrete floors, gypsum concrete floors, wood floors, wood sub-floors or other types of subfloors, and a) forms a stained or solid colored finished floor that is i) easy to clean, ii) antimicrobial, and/or iii) highly durable, b) provides an alternative to floor covers such as tile, wood, linoleum, manufactured store/tile, stone, carpet, vinyl composition tile (VCT), ceramic tiles, hardwoods, wood floors, laminate, porcelain, natural stone, or other flooring materials, c) maintains or improves the fire rating of the floor, d) improves anti-microbial properties of the floor surface, e) improves the durability of floor surface, and/or f) simplifies the care and/or maintenance of the floor surface.

### BACKGROUND OF THE INVENTION

A common issue associated with the installation of floors in multi-family projects is providing a cost-effective floor that meets the fire resistance requirements for the structure. In many structures, expensive concrete floors or gypsum concrete floors are laid, or special fire-resistant sub-flooring is installed to meet the fire safety standards for the structure. Concrete floors add significant weight to the floor, thereby increasing the structural costs for the structure to support the additional floor weight. Also, installation of concrete floors can delay the building project due to the required setting times of the concrete and the general requirement that a complete floor or floor section needs to be laid at one time with concrete, thus causing delays in the installation of other structures in the building project until the concrete floor is installed and set.

Another type of fire-resistant floor includes the use of magnesium cement floorboards. Generally caulking is inserted between the edges of the magnesium cement floorboards to seal the gaps between the magnesium cement floorboards. Currently, there is not acceptable way to apply a finish over the magnesium cement board, thus expensive materials such as tile, wood, and other designer options are laid over the top of the magnesium cement floorboards. When the property is to be resold, or after standard life of such applied materials on the top of the magnesium cement floorboards has expired due to their staining, blemishing, deterioration, and/or overall lifespan properties, such applied materials (e.g., tile, wood, and other designer options) must be removed and reinstalled with new materials, thus adding significant cost.

In view of the current state of technology regarding the installation of the fire-resistant floors, there is a need for a fire-resistant floor that a) is cost-effective to install such that the floor has reduced costs during initial installation, and which floor can be later cost effectively be repaired and/or refinished by a property owner, b) provides an alternative to floor covers such as tile, wood, linoleum, manufactured store/tile, stone, carpet, vinyl composition tile (VCT), ceramic tiles, hardwoods, wood floors, laminate, porcelain, natural stone, or other flooring materials, c) maintains or improves the fire rating of the floor, d) improves the anti-microbial properties of floor surface, e) improves the durability of floor surface, and/or f) simplifies the care and/or maintenance of the floor surface.

### SUMMARY OF DISCLOSURE

The present disclosure is directed to an improved flooring system that includes a multi-layered coating that forms a durable finish a top surface of various types of floors, floorboards and/or sub-board surfaces (e.g., magnesium cement floorboards, concrete floors, gypsum concrete floors, wood floors, wood sub-floors or other types of subfloors, composite wood sub-floors, tile floors, stone floors, etc.). The improved flooring system can be used to a) forms a stained or solid colored finished floor that is i) easy to clean, ii) antimicrobial, and/or iii) highly durable, b) provides an alternative to floor covers such as tile, wood, linoleum, manufactured store/tile, stone, carpet, vinyl composition tile (VCT), ceramic tiles, hardwoods, wood floors, laminate, porcelain, natural stone, or other flooring materials, c) maintains or improves the fire rating of the floor, d) improves anti-microbial properties of the floor surface, e) improves the durability of floor surface, and/or f) simplifies the care and/or maintenance of the floor surface. The improved flooring system can be used to provide a fire-resistant floor that a) is cost-effective to install such that the floor has reduced costs during initial installation, and which floor can be later cost effectively be repaired and/or refinished by a property owner, b) provides an alternative to floor covers such as tile, wood, linoleum, manufactured store/tile, stone, carpet, vinyl composition tile (VCT), ceramic tiles, hardwoods, wood floors, laminate, porcelain, natural stone, or other flooring materials, c) maintains or improves the fire rating of the floor, d) improves the anti-microbial properties of floor surface, e) improves the durability of floor surface, and/or f) simplifies the care and/or maintenance of the floor surface. The improved flooring system can be used a cost-effective floor that has reduced costs during initial installation, and which floor can be later cost effectively repaired and/or refinished by a property owner. The improved flooring system can also be used as an asbestos encapsulation to encapsulate and seal asbestos materials that form the floor materials and/or are located under the flooring (e.g., asbestos insulation under the flooring, etc.).

In one non-limiting aspect of the present disclosure, there is a provided a multi-layered coating that forms a durable finish a top surface on various types of floors, floorboards and/or sub-board surfaces. In one non-limiting embodiment, the multi-layered coating includes a) a cementitious layer that is applied on or above the top surface the floor, floorboards and/or sub-board, b) an optional resinous color/stain layer that is applied to the top surface of the cementitious layer, and c) a polymer coating (e.g., polyaspartic aliphatic polyurea coating [e.g., polyaspartic clear coat [i.e., coating formed from aliphatic polyisocyanate and a polyaspartic ester], etc.], etc.) that is either applied to the top surface of the cementitious layer when the optional resinous color/stain layer is not used, or on the top surface of the optional resinous color/stain layer when the optional resinous color/stain layer is used.

In another and/or alternative non-limiting aspect of the present disclosure, the floor surface that the multi-layered coating is to be applied to is fiber cement board (e.g., Portland cement fiber board, magnesium cement fiber board, gypsum cement fiber board, etc.). In one non-limiting embodiment, the fiber cement board is magnesium cement fiber board. The thickness of the fiber cement board is generally 0.1-2 inches (and all values and ranges therebetween). The length and width of the fiber cement board is non-limiting (e.g., 0.5-10 ft. wide and 0.5-20 ft. long and all values and ranges therebetween). The composition of the cement fiber board is non-limiting. In one non-limiting configuration, the cement fiber board is partially or fully formed of 30-87 wt.% (and all values and ranges therebetween) cement mixture (e.g., Portland cement, magnesium oxide cement, gypsum cement, etc.), 10-40 wt.% (and all values and ranges therebetween) filler (e.g., kaolin, silica sand, limestone, metakaolin, fly ash, fly ash pozzolans, perlite, glass, etc.), 0-15 wt.% (and all values and ranges therebetween) wood fiber and/or cellulose, 0-20 wt.% (and all values and ranges therebetween) mica, 0-20 wt.% (and all values and ranges therebetween) optional additives (e.g., aluminum stearate, polyvinyl alcohol fibers (PVA fibers), cenospheres, fiberglass fiber, etc.), and 0-35 wt.% (and all values and ranges therebetween) fiber layer (e.g., woven fiberglass mesh or other material mesh, non-woven fiberglass layer or other material layer, etc.). In one non-limiting specific composition, the cement fiber board is a magnesium cement board (e.g., MgO board) that includes 45-65 wt.% (and all values and ranges therebetween) magnesium oxide (and all values and ranges therebetween), 20-35 wt.% magnesium chloride and/or or magnesium sulfate (and all values and ranges therebetween), 10-40 wt.% (and all values and ranges therebetween) filler (e.g., kaolin, silica sand, limestone, metakaolin, fly ash, fly ash pozzolans, perlite, glass, etc.), 0-15 wt.% (and all values and ranges therebetween) wood fiber and/or cellulose, 0-20 wt.% (and all values and ranges therebetween) mica, 0-20 wt.% (and all values and ranges therebetween) optional additives (e.g., aluminum stearate, polyvinyl alcohol fibers (PVA fibers), cenospheres, fiberglass fiber, etc.), and 0-35 wt.% fiber layer(and all values and ranges therebetween) (e.g., woven fiberglass mesh or other material mesh, non-woven fiberglass layer or other material layer, etc.). The fiber cement board can form the sub-floor or be connected to a sub-floor. In one non-limiting configuration, the fiber cement board is generally connected to a sub-floor or structures below the sub-floor by nails, screws, adhesive, bolts, staples, etc.).

In another and/or alternative non-limiting aspect of the present disclosure, the floor surface that the multi-layered coating is to be applied to is fiber cement board, and wherein a filler material is optionally inserted between adjacently positioned fiber cement boards to partially or fully fill the gaps between the adjacently positioned fiber cement boards. The composition of such filler material is non-limiting (e.g., thin-set mortar (e.g., cement, fine sand, and a water retaining agent, etc.), joint filler, skim coating (e.g., plaster, mud, gypsum and additives, etc.), polymer caulk, urethane caulk, epoxy resin filler, polyurethane filler, polyurea filler, silicone filler, or acrylic filler, etc.). The filler material can be optionally sanded down or otherwise removed to form a level or near level surface with the top surface of the adjacently positioned fiber cement boards.

In another and/or alternative non-limiting aspect of the present disclosure, the cementitious layer in the multi-layered coating that is applied on or above the top surface the floor, floorboards and/or sub-board can be a self-leveling or non-self-leveling cementitious layer. The cementitious layer can include one or more materials such as, but not limited to, Portland cement or magnesium cement, expanding agent (e.g., calcium sulphate, powdered aluminum, calcium carbide, quicklime, hydrogen peroxide, powdered iron, calcium hypochlorite, magnesium oxide, vinyl resin, alumina, gypsum, etc.), filler (e.g., sand, blast furnace slag, gravel, ceramic and/or glass balls, etc.) stabilizer (e.g., calcium abietate, clay, sodium bicarbonate, potassium bicarbonate, alumina colloid, fly-ash, hydraulic lime, cellulose ether, alkylcellulose, sodium silicate, etc.), plasticizer, gelling retarder, defoamer, colloidal agent and/or a water retention agent. In one non-limiting formulation, the Portland cement includes 50-75 wt.% (and all values and ranges therebetween) lime (CaO), 10-30 wt.% (and all values and ranges therebetween) silica (SiO₂), 1-10 wt.% (and all values and ranges therebetween) alumina (Al₂O₃), 1-10 wt.% (and all values and ranges therebetween) iron oxide (Fe₂O₃), 1-8 wt.% (and all values and ranges therebetween) gypsum, and 0.1-6 wt.% (and all values and ranges therebetween) magnesia (MgO). In another non-limiting formulation, the magnesium cement includes 40-90 wt.% (and all values and ranges therebetween) magnesia, 4-40 wt.% (and all values and ranges therebetween) magnesium sulfate, and 2-25 wt.% (and all values and ranges therebetween) pulp, cellulose, fibrous glass, etc. In another non-limiting formulation, the cementitious layer, in dry form, includes 3-45 wt.% (and all values and ranges therebetween) Portland cement or magnesium cement, 0.5-40 wt.% (and all values and ranges therebetween) expanding agent, 5-40 wt.% (and all values and ranges therebetween) filler, 0-15 wt.% (and all values and ranges therebetween) stabilizer, 0-8 wt.% (and all values and ranges therebetween) plasticizer, 0-6 wt.% (and all values and ranges therebetween) gelling retarder, 0-6 wt.% (and all values and ranges therebetween) defoamer, 0-6 wt.% (and all values and ranges therebetween) colloidal agent and/or 0-6 wt.% (and all values and ranges therebetween) water retention agent. The dry cementitious can be mixed with water to prepare a flowable/spreadable composition. In one non-limiting embodiment, the thickness of cementitious layer that is applied to the top surface of the floor, floorboards and/or sub-board is at least 0.2 inches (e.g., 0.2-3 inches and all values and ranges therebetween).

In another and/or alternative non-limiting aspect of the present disclosure, the optional resinous color/stain layer that is applied to the top surface of the cementitious layer is formulated to a) provide a color, visual pattern and/or surface texture on the top surface cementitious layer, b) form a protective or durable or wear-resistance layer, and/or c) form a waterproof layer. The composition of the resinous color/stain layer is non-limiting. In one non-limiting embodiment, the resinous color/stain layer includes resin (e.g., alkyd resin, epoxy resin, acrylic resin, etc.), optional oil (e.g., linseed oil, soy oil, safflower oil, walnut oil, etc.), pigment, solvent (e.g., water, hydrocarbon solvent, esters, ketones, alcohols, ethers, etc.), and optional additive (e.g., UV inhibitor, dryers, mildewcides, preservatives, surfactant, wax, etc. The color of the resinous color/stain is non-limiting. The thickness of the resinous color/stain is at least 0.001 inches (e.g., 0.001-0.25 inches and all values and ranges therebetween). The method that the resinous color/stain layer is applied to the top surface of the cementitious layer is non-limiting (e.g., brush application, roller application, spray application, etc.). Generally, the resinous color/stain layer is applied to the top surface of the cementitious layer after the cementitious layer has partially (e.g., 20-99.999% set or cured and all values and ranges therebetween) or fully set or cured.

In another and/or alternative non-limiting aspect of the present disclosure, the polymer coating that is either applied to the top surface of the cementitious layer when the optional resinous color/stain layer is not used, or on the top surface of the optional resinous color/stain layer when the optional resinous color/stain layer is used is formulated to form a sealing coating (waterproof coating, etc.) and/or a durable coating on the top surface of the cementitious layer or optional resinous color/stain layer. The polymer coating can optionally include additives (e.g., UV agents to enhance resistance to damage from UV exposure, antimicrobial agents to enhance resistance to microbial growth on the polymer coating, colorants/pigments to customize the color and/or degree of opacity of the polymer coating, etc.). The thickness of the polymer coating is at least 0.001 inches (e.g., 0.001-0.25 inches and all values and ranges therebetween). The method that the polymer coating is applied to the top surface of the cementitious layer or optional resinous color/stain layer is non-limiting (e.g., brush application, roller application, spray application, etc.). The color of the polymer coating is non-limiting (e.g., clear, opaque, colored, etc.). When the polymer coating is applied to the top surface of the cementitious layer or optional resinous color/stain layer, the polymer coating can be applied as a) a smooth and/or uniform coating to the top surface of the cementitious layer or optional resinous color/stain layer, and/or b) a textured surface to the top surface of the cementitious layer or optional resinous color/stain layer. In one non-limiting embodiment, the polymer coating is a polyaspartic clear coat.

In another and/or alternative non-limiting aspect of the present disclosure, after the floor surface in accordance with the present disclosure is installed, the floor system can function as the final floor surface, be partially or fully covered by rugs or mats, and/or be partially or fully covered by tile, wood, linoleum, manufactured store/tile, stone, carpet, vinyl composition tile (VCT), ceramic tiles, hardwoods, wood floors, laminate, porcelain, natural stone, or other flooring materials.

In one non-limiting object of the present disclosure is the provision of a multi-layered coating that forms a durable finish a top surface of various types of floors, floorboards and/or sub-board surfaces (e.g., magnesium cement floorboards, concrete floors, gypsum concrete floors, wood floors, wood sub-floors or other types of subfloors, composite wood sub-floors, tile floors, stone floors, etc.).

In another and/or alternative non-limiting object of the present disclosure is the provision of an improved flooring system that can be used to a) forms a stained or solid colored finished floor that is i) easy to clean, ii) antimicrobial, and/or iii) highly durable, b) provides an alternative to floor covers such as tile, wood, linoleum, manufactured store/tile, stone, carpet, vinyl composition tile (VCT), ceramic tiles, hardwoods, wood floors, laminate, porcelain, natural stone, or other flooring materials, c) maintains or improves the fire rating of the floor, d) improves anti-microbial properties of the floor surface, e) improves the durability of floor surface, and/or f) simplifies the care and/or maintenance of the floor surface. The improved flooring system can be used to provide a fire-resistant floor that a) is cost-effective to install such that the floor has reduced costs during initial installation, and which floor can be later cost effectively be repaired and/or refinished by a property owner, b) provides an alternative to floor covers such as tile, wood, linoleum, manufactured store/tile, stone, carpet, vinyl composition tile (VCT), ceramic tiles, hardwoods, wood floors, laminate, porcelain, natural stone, or other flooring materials, c) maintains or improves the fire rating of the floor, d) improves the anti-microbial properties of floor surface, e) improves the durability of floor surface, and/or f) simplifies the care and/or maintenance of the floor surface.

In another and/or alternative non-limiting object of the present disclosure is the provision of an improved flooring system that can be used a cost-effective floor that has reduced costs during initial installation, and which floor can be later cost effectively repaired and/or refinished by a property owner.

In another and/or alternative non-limiting object of the present disclosure is the provision of an improved flooring system that can be used as an asbestos encapsulation to encapsulate and seal asbestos materials that form the floor materials and/or are located under the flooring (e.g., asbestos insulation under the flooring, etc.).

In another and/or alternative non-limiting object of the present disclosure is the provision of an improved flooring system comprising: a) a floor surface or floor sub-surface; and b) a multi-layered coating that is positioned on or above a top surface of the floor surface or floor sub-surface; the multi-layered coating comprising i) a cementitious layer that is applied on or above the top surface the floor surface or floor sub-surface, ii) a resinous color/stain layer and/or polymer coating; the polymer coating is the top layer of the multi-layered coating.

In another and/or alternative non-limiting object of the present disclosure is the provision of an improved flooring system wherein a) the resinous color/stain layer is positioned on a top surface of the cementitious layer and the polymer layer is positioned on a top surface of the resinous color/stain layer, or b) the polymer layer is positioned on the top surface of the cementitious layer, and the multi-layered coating is absent the resinous color/stain layer.

In another and/or alternative non-limiting object of the present disclosure is the provision of an improved flooring system wherein the floor surface or floor sub-surface includes cement boards.

In another and/or alternative non-limiting object of the present disclosure is the provision of an improved flooring system wherein the cement boards include boards that are selected from the group consisting of magnesium cement fiber boards, cement fiber boards, and gypsum concrete fiber floors.

In another and/or alternative non-limiting object of the present disclosure is the provision of an improved flooring system wherein the cement board is a magnesium cement fiber boards.

In another and/or alternative non-limiting object of the present disclosure is the provision of an improved flooring system further including a filler material that is inserted between one or more gaps between the floor surface or floor sub-surface; the filler includes one or more materials selected from the group consisting of thin-set mortar, joint filler, skim coating, polymer caulk, urethane caulk, epoxy resin filler, polyurethane filler, polyurea filler, silicone filler, and acrylic filler.

In another and/or alternative non-limiting object of the present disclosure is the provision of an improved flooring system wherein the cementitious layer is a self-leveling material.

In another and/or alternative non-limiting object of the present disclosure is the provision of an improved flooring system wherein the resinous color/stain layer includes one or more resins selected from the group consisting of alkyd resin, epoxy resin and acrylic resin.

In another and/or alternative non-limiting object of the present disclosure is the provision of an improved flooring system wherein the resinous color/stain layer has a thickness of at least 0.001 inches.

In another and/or alternative non-limiting object of the present disclosure is the provision of an improved flooring system wherein the polymer coating has a thickness of at least 0.001 inches.

In another and/or alternative non-limiting object of the present disclosure is the provision of an improved flooring system wherein the polymer coating is or includes a polyaspartic material.

In another and/or alternative non-limiting object of the present disclosure is the provision of a method for forming a flooring system comprising: a) providing a floor materials used to form a floor surface or sub-floor surface; b) installing the floor materials to form the floor surface or sub-floor surface; and, c) applying a multi-layered coating on or above a top surface of the floorboards or sub-boards; the multi-layered coating includes i) a cementitious layer that is applied on or above the top surface the floor surface or sub-floor surface, ii) a resinous color/stain layer and/or polymer coating; the polymer coating is the top layer of the multi-layered coating.

Other objects, advantages, and novel features of the present disclosure will become apparent from the following detailed description of the disclosure.

### BRIEF DESCRIPTION OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. Reference may now be made to the drawings, which illustrate various embodiments that the disclosure may take in physical form and in certain parts and arrangement of parts wherein:

FIG. 1 is an illustration of a cross-section of one non-limiting floor system in accordance with the present disclosure.

FIG. 2 is an illustration of a cross-section of another non-limiting floor system in accordance with the present disclosure.

FIG. 3 is an illustration of a cross-section of a section of another non-limiting floor system in accordance with the present disclosure.

### DESCRIPTION OF NON-LIMITING EMBODIMENTS

A more complete understanding of the articles/devices, processes and components disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any unavoidable impurities that might result therefrom, and excludes other ingredients/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values and ranges therebetween).

The terms “about” and “approximately” can be used to include any numerical value that can vary without changing the basic function of that value. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number.

Percentages of elements should be assumed to be percent by weight of the stated element, unless expressly stated otherwise.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

For the sake of simplicity, the attached figures may not show the various ways (readily discernable, based on this disclosure, by one of ordinary skill in the art) in which the disclosed system, method and apparatus can be used in combination with other systems, methods and apparatuses. Additionally, the description sometimes uses terms such as “produce” and “provide” to describe the disclosed method. These terms are abstractions of the actual operations that can be performed. The actual operations that correspond to these terms can vary depending on the particular implementation and are, based on this disclosure, readily discernible by one of ordinary skill in the art.

The present disclosure is directed to an improved flooring system that includes a multi-layered coating that forms a durable finish a top surface of various types of floors, floorboards and/or sub-board surfaces (e.g., magnesium cement floorboards, concrete floors, gypsum concrete floors, wood floors, wood sub-floors or other types of subfloors, composite wood sub-floors, tile floors, stone floors, etc.). The improved flooring system can be used to a) forms a stained or solid colored finished floor that is easy to clean, antimicrobial, and/or is highly durable, b) provides an alternative to floor covers such as tile, wood, linoleum, manufactured store/tile, stone, carpet, vinyl composition tile (VCT), ceramic tiles, hardwoods, wood floors, laminate, porcelain, natural stone, or other flooring materials, c) maintains or improves the fire rating of the floor, d) improves anti-microbial properties of floor surface, e) improves durability of floor surface, and/or f) simplifies the care and/or maintenance of the floor surface. The improved flooring system can be used to provide a cost-effective floor that has reduced costs during initial installation, and which floor can be later cost effectively repaired and/or refinished by a property owner. In one non-limiting embodiment, the magnesium cement floorboard includes 45-65 wt.% (and all values and ranges therebetween) magnesium oxide, 20-35 wt.% (and all values and ranges therebetween) magnesium chloride and/or magnesium sulfate, 1-10 wt.% (and all values and ranges therebetween) filler (e.g., perlite, etc.), 1-10 wt.% (and all values and ranges therebetween) wood fiber and/or cellulose, 1-10 wt.% (and all values and ranges therebetween) reinforcement layer or mesh, (e.g., reinforcing fiberglass mesh, etc.).

In one non-limiting embodiment of the present disclosure, there is a provided a multi-layered coating that forms a durable finish a top surface of various types of floors, floorboards and/or sub-board surfaces. One non-limiting surface is the top surface of a fiber cement board (e.g., magnesium cement fiber board, etc.). The multi-layered coating includes a) a cementitious layer that is applied on or above the top surface the floor, floorboards and/or sub-board, b) an optional resinous color/stain layer that is applied to the top surface of the cementitious layer, and c) a polymer coating that is applied to the top surface of the resinous color/stain layer. In one non-limiting arrangement, the floor surface is fiber cement board such as magnesium cement fiber board. A filler material is optionally inserted between adjacently positioned fiber cement boards to partially of fully fill the gaps between the adjacently positioned fiber cement boards. The cementitious layer that is applied on the top surface of the fiber cement boards can be a self-leveling to non-self-leveling cementitious layer. The thickness of cementitious layer is at least 0.2 inches (e.g., 0.2-3 inches and all values and ranges therebetween). Known techniques can be used to apply the cementitious layer to the top surface of a fiber cement board. Generally, the top surface of the cementitious layer is smooth; however, textured/or patterned surfaces can be formed on the top surface of the cementitious layer. The resinous color/stain layer that is applied to the top surface of the cementitious layer is formulated to provide a color, visual pattern and/or surface texture on the top surface cementitious layer. In one non-limiting embodiment, the resinous color/stain layer includes resin, optional pigment, solvent, optional other ingredients. The thickness of the resinous color/stain is at least 0.001 inches (e.g., 0.001-0.25 inches and all values and ranges therebetween). The method that the resinous color/stain layer is applied to the top surface of the cementitious layer is non-limiting (e.g., brush application, roller application, spray application, etc.). Generally, the resinous color/stain layer is applied to the top surface of the cementitious layer after the cementitious layer has partially or fully set or cured. The polymer coating that is applied to the top surface of the resinous color/stain layer is formulated to form a sealing coating and/or a durable coating on the top surface of the resinous color/stain layer. The thickness of the polymer coating is at least 0.001 inches (e.g., 0.001-0.25 inches and all values and ranges therebetween). The method that the polymer coating is applied to the top surface of the cementitious layer or optional resinous color/stain layer is non-limiting (e.g., brush application, roller application, spray application, etc.). The color of the polymer coating is non-limiting (e.g., clear, opaque, colored, etc.). When the polymer coating is applied to the top surface of the cementitious layer or optional resinous color/stain layer, the polymer coating can be applied as a) a smooth and/or uniform coating to the top surface of the cementitious layer or optional resinous color/stain layer, and/or b) a textured surface to the top surface of the cementitious layer or optional resinous color/stain layer. In one non-limiting embodiment, the polymer coating is a polyaspartic clear coat.

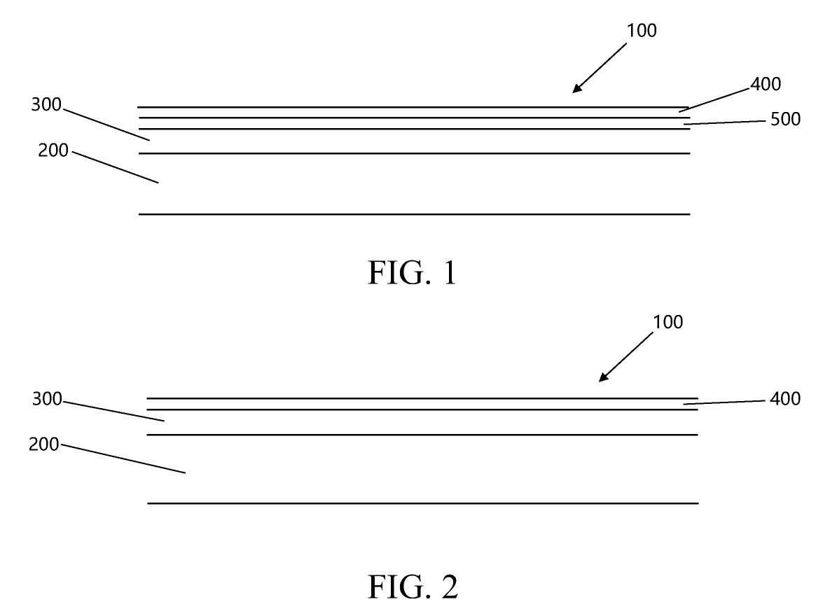

Referring now to FIGS. 1-3, there are illustrated cross-sections of three sections of non-limiting floor systems 100 in accordance with the present disclosure. Referring to FIG. 1, the floor system 100 includes a fiber cement board 200, a cementitious layer 300 that is applied on the top surface the fiber cement board 200, a resinous color/stain layer 500 that is applied to the top surface of the cementitious layer 200, and a polymer coating 400 that is applied to the top surface of the resinous color/stain layer 500. Referring to FIG. 2, the floor system 100 includes a fiber cement board 200, a cementitious layer 300 that is applied on the top surface the fiber cement board 200, and a polymer coating 400 that is applied to the top surface of the cementitious layer 300. As illustrated in FIGS. 1 and 2, the cementitious layer 200 generally has thickness that is greater than the thickness of each of polymer coating 400 and resinous color/stain layer 500. The thickness of the cementitious layer 200 can be greater than, the same as, or less than the thickness of the fiber cement board 200. After the floor system 100 is installed, the floor system 100 can function as the final floor surface, be partially or fully covered by rugs or mats, and/or be partially or fully covered by tile, wood, linoleum, manufactured store/tile, stone, carpet, vinyl composition tile (VCT), ceramic tiles, hardwoods, wood floors, laminate, porcelain, natural stone, or other flooring materials.

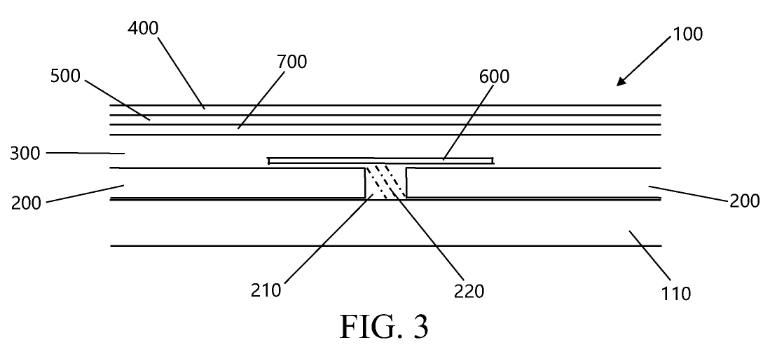

Referring to FIG. 3, the floor system 100 includes a subfloor 110. The subfloor 110 can be a cement floor, wood or steel beams, a plywood floor, etc. Two cement boards 200 are positioned on the top surface of the subfloor 110. The two cement boards 200 can be connected to the surface of the subfloor 110 by any mechanism (e.g., adhesive, nail, screw, staples, tacks, etc.). A gap 210 is illustrated as formed between the adjacently positioned cement boards 200. A filler 220 can be optionally positioned in the gap 210 to partially or fully fill the gap 210. A seal tape 600 can be optionally positioned over the gap 210. The optional seal tape 600 can be optionally secured to the top surface of the cement boards 200 by any means (e.g., adhesive, mortar, joint compound, tacks, staples, nails, screws, etc.). A cementitious layer 300 that is applied on the top surface the cement board 200. An optional liquid barrier polymer layer 700 is applied to the top surface of the cementitious layer 300. An optional resinous color/stain layer 500 is applied to the top surface of the optional liquid barrier polymer layer 700. A top polymer coating 400 that is applied to the top surface of the resinous color/stain layer 500.

As illustrated in FIGS. 1-3, the cementitious layer 200 generally has a thickness that is greater than the thickness of each of top polymer coating 400, optional resinous color/stain layer 500 and optional liquid barrier polymer layer 700. The thickness of the cementitious layer 200 can be greater than, the same as, or less than the thickness of the cement board 200. The thickness of each of top polymer coating 400, optional resinous color/stain layer 500 and optional liquid barrier polymer layer 700 can be the same or different.

After the floor system 100 is installed, the floor system 100 can function as the final floor surface, be partially or fully covered by rugs or mats, and/or be partially or fully covered by tile, wood, linoleum, manufactured store/tile, stone, carpet, vinyl composition tile (VCT), ceramic tiles, hardwoods, wood floors, laminate, porcelain, natural stone, or other flooring materials.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

It will thus be seen that the objects set forth above, among those made apparent from the preceding description, are efficiently attained, and since certain changes may be made in the constructions set forth without departing from the spirit and scope of the disclosure, it is intended that all matter contained in the above description and shown in the accompanying drawings shall be interpreted as illustrative and not in a limiting sense. The disclosure has been described with reference to preferred and alternate embodiments. Modifications and alterations will become apparent to those skilled in the art upon reading and understanding the detailed discussion of the disclosure provided herein. This disclosure is intended to include all such modifications and alterations insofar as they come within the scope of the present disclosure. It is also to be understood that the following claims are intended to cover all of the generic and specific features of the disclosure herein described and all statements of the scope of the disclosure, which, as a matter of language, might be said to fall there between. The disclosure has been described with reference to the certain embodiments. These and other modifications of the disclosure will be obvious from the disclosure herein, whereby the foregoing descriptive matter is to be interpreted merely as illustrative of the disclosure and not as a limitation. It is intended to include all such modifications and alterations insofar as they come within the scope of the appended claims.

To aid the Patent Office and any readers of this application and any resulting patent in interpreting the claims appended hereto, Applicant does not intend any of the appended claims or claim elements to invoke 35 U.S.C. 112(f) unless the words “means for” or “step for” are explicitly used in the particular claim.

What is claimed:

1. A flooring system comprising:
1a. a floor surface or floor sub-surface; and
1b. a multi-layered coating that is positioned on or above a top surface of said floor surface or floor sub-surface; said multi-layered coating comprising a) a cementitious layer that is applied on or above said top surface said floor surface or floor sub-surface, b) a resinous color/stain layer and/or polymer coating; said polymer coating is the top layer of said multi-layered coating.

2. The flooring system as defined in claim 1, wherein a) said resinous color/stain layer is positioned on a top surface of said cementitious layer and said polymer layer is positioned on a top surface of said resinous color/stain layer, or b) said polymer layer is positioned on said top surface of said cementitious layer, and said multi-layered coating is absent said resinous color/stain layer.

3. The flooring system as defined in claim 1, wherein said floor surface or floor sub-surface includes cement boards.

4. The flooring system as defined in claim 3, wherein said cement boards include boards that are selected from the group consisting of magnesium cement fiber boards, cement fiber boards, and gypsum concrete fiber floors.

5. The flooring system as defined in claim 4, wherein said cement board is a magnesium cement fiber boards.

6. The flooring system as defined in claim 3, further including a filler material that is inserted between one or more gaps between said floor surface or floor sub-surface; said filler includes one or more materials selected from the group consisting of thin-set mortar, joint filler, skim coating, polymer caulk, urethane caulk, epoxy resin filler, polyurethane filler, polyurea filler, silicone filler, and acrylic filler.

7. The flooring system as defined in claim 1, wherein said cementitious layer is a self-leveling material.

8. The flooring system as defined in claim 1, wherein said resinous color/stain layer includes one or more resins selected from the group consisting of alkyd resin, epoxy resin and acrylic resin.

9. The flooring system as defined in claim 1, wherein said resinous color/stain layer has a thickness of at least 0.001 inches.

10. The flooring system as defined in claim 1, wherein said polymer coating has a thickness of at least 0.001 inches.

11. The flooring system as defined in claim 1, wherein said polymer coating is or includes a polyaspartic material.

12. A method for forming a flooring system comprising:
a. providing a floor materials used to form a floor surface or sub-floor surface;
b. installing said floor materials to form said floor surface or sub-floor surface; and,
c. applying a multi-layered coating on or above a top surface of said floorboards or sub-boards; said multi-layered coating includes i) a cementitious layer that is applied on or above said top surface said floor surface or sub-floor surface, ii) a resinous color/stain layer and/or polymer coating; said polymer coating is the top layer of said multi-layered coating.

13. The method as defined in claim 12, wherein I) said resinous color/stain layer is positioned on a top surface of said cementitious layer and said polymer layer is positioned on a top surface of said resinous color/stain layer, or II) said polymer layer is positioned on said top surface of said cementitious layer, and said multi-layered coating is absent said resinous color/stain layer.

14. The method as defined in claim 12, wherein floor surface or sub-floor surface includes a plurality of floorboards or sub-boards; said plurality of floorboards or sub-boards include cement boards.

15. The method as defined in claim 14, wherein said cement boards include boards that are selected from the group consisting of magnesium cement fiber boards, cement fiber boards, and gypsum concrete fiber floors.

16. The method as defined in claim 15, wherein said cement boards is magnesium cement fiber boards.

17. The method as defined in claim 14, further including providing a filler material, and further including the step of inserting said filler between one or more gaps between said floorboards or sub-boards; said filler includes one or more materials selected from the group consisting of thin-set mortar, joint filler, skim coating, polymer caulk, urethane caulk, epoxy resin filler, polyurethane filler, polyurea filler, silicone filler, and acrylic filler.

18. The method as defined in claim 12, wherein said cementitious layer is a self-leveling material.

19. The method as defined in claim 12, wherein said resinous color/stain layer includes one or more resins selected from the group consisting of alkyd resin, epoxy resin and acrylic resin.

20. The method as defined in claim 12, wherein said resinous color/stain layer has a thickness of at least 0.001 inches.

21. The method as defined in claim 12, wherein said polymer coating has a thickness of at least 0.001 inches.

22. The method as defined in claim 12, wherein said polymer coating is or includes a polyaspartic material.
